(19) United States
(12) Patent Application Publication
(10) Pub. No.: US 2016/0180444 A1
(43) Pub. Date: Jun. 23, 2016

(54) MULTI-CART CONCURRENT DIGITAL E-BOOK TRANSACTIONS

(71) Applicant: KOBO INCORPORATED, Toronto (CA)

(72) Inventor: Vanessa GHOSH, Toronto (CA)

(73) Assignee: KOBO INCORPORATED, Toronto (CA)

(21) Appl. No.: 14/575,394

(22) Filed: Dec. 18, 2014

(51) Int. Cl. G06Q 30/06; G06F 3/01; G06F 3/0481; G06F 3/0488

(52) U.S. Cl. CPC G06Q 30/0633; G06F 3/04883; G06F 3/017; G06F 3/04817; G06Q 30/0641

(57) ABSTRACT

Methods and systems for multi-cart concurrent digital e-Book transactions are provided. A distinct gesture is correlated with each of a plurality of e-book recipients. Determining when the distinct gesture correlated with one of the plurality of e-book recipients is performed on at least one e-book in an e-bookstore. Automatically placing the at least one e-book identified by the distinct gesture correlated with one of the plurality of e-book recipients into a portion of a shopping multi-cart designated for the one of the plurality of e-book recipients.

### TECHNICAL FIELD

Examples described herein relate to multi-cart concurrent digital e-Book transactions.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reading device) devices typically link to an online bookstore, and media playback devices often include applications that enable the user to access an online median electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device, in an embodiment.

FIG. 2 illustrates an example architecture configuration of a computing device, according to an embodiment.

FIG. 3 illustrates a diagram of an exemplary e-library shopping page on an e-reading device, according to an embodiment.

FIG. 4 illustrates a screen-shot type diagram of an c-library store checkout page, according to an embodiment.

FIG. 5 illustrates a method of implementing multi-cart concurrent digital e-Book transactions, according to an embodiment.

FIG. 6 illustrates an exemplary computer system for implementing multi-cart concurrent digital e-Book transactions, according to an embodiment.

### DETAILED DESCRIPTION

Multi-cart concurrent digital e-Book transactions are disclosed. That is, in one embodiment, a user's e-bookstore home page shows e-book selections that are available for purchase and allows the purchaser to identify different users as recipients for purchased e-book(s). In one embodiment, a multi-cart concurrent shopping method utilizes multi-recipient carts that are previously identified by certain predefined gestures. Then, while browsing the store, the user selects books for different recipients by drawing one or more of the predefined gestures on the book cover.

For example, prior to using the cart, the user assigns gestures to specific e-library accounts. For example, if John is the user, he may assign a gesture in the shape of a “J” as making a book purchase for his own account. Similarly, he assigns a gesture in the shape of an “M” as making a book purchase for his friend Mary's account. Thus, when shopping, John can quickly swipe “J”s on the covers of the books he would like to purchase for himself and “M”s on the covers of the books he would like to purchase for Mary.

Thus, when John views his cart, he will see a list of books for each user (himself and Mary) which, in one embodiment, he can confirm as being correct before finalizing the purchases. In another embodiment, the enacted gesture both identifies the gift recipient and also consummates the purchases.

In general, “E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books).

Multi-function devices, such as cellular-telephony or messaging devices, can utilize specialized applications (e.g., specialized e-reading application software) to view e-books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an c-reading device, such as a purpose-built device that is optimized for an e-reading experience (e.g., with E-ink displays).

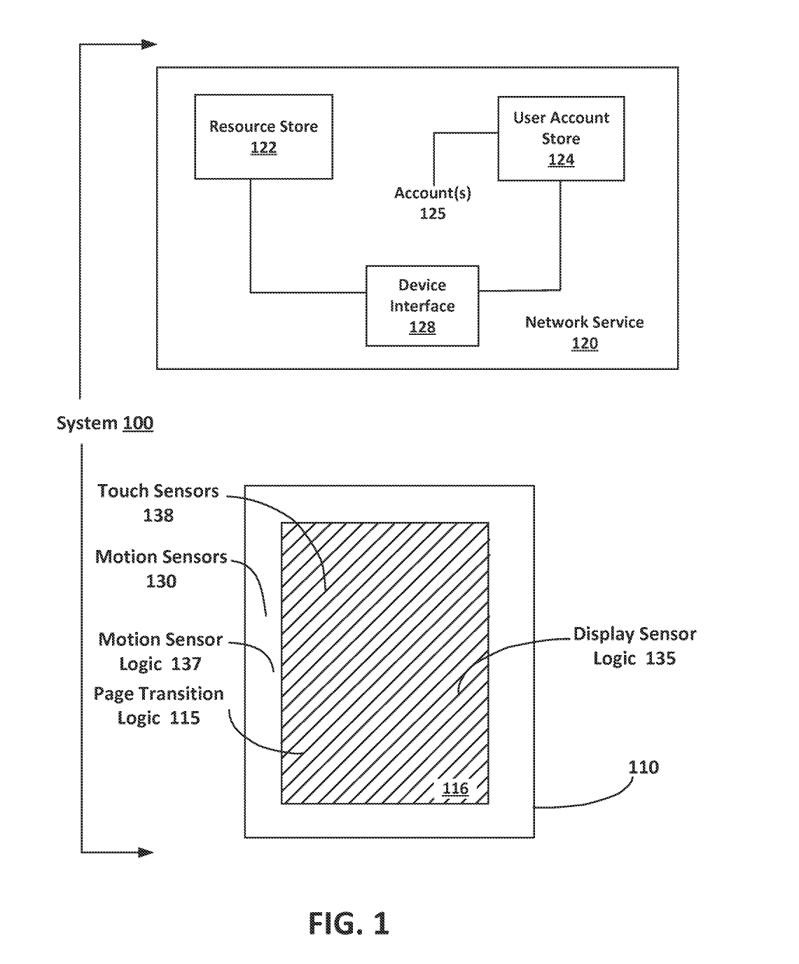

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services that communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading device application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the resource store 122, which can include, for example, an online store. The device interface 128 can handle input to identify content items (e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display 116 and an optional housing, not shown. In an embodiment, the display 116 is touch-sensitive, to process touch inputs including gestures (e.g., swipes). For example, the display 116 may be integrated with one or more touch sensors 138 to provide a touch-sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can be integrated with touch sensors to provide one or more touch sensing regions, for example, on the bezel and/or back surface of the housing.

E-reading device 110 can also optionally include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

E-reading device 110 further includes motion sensor logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion sensor logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display 116, during which sustained contact period the user or observer may take additional input actions, including gestures, on display 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display 116 for the purpose of associating respective input commands therewith.

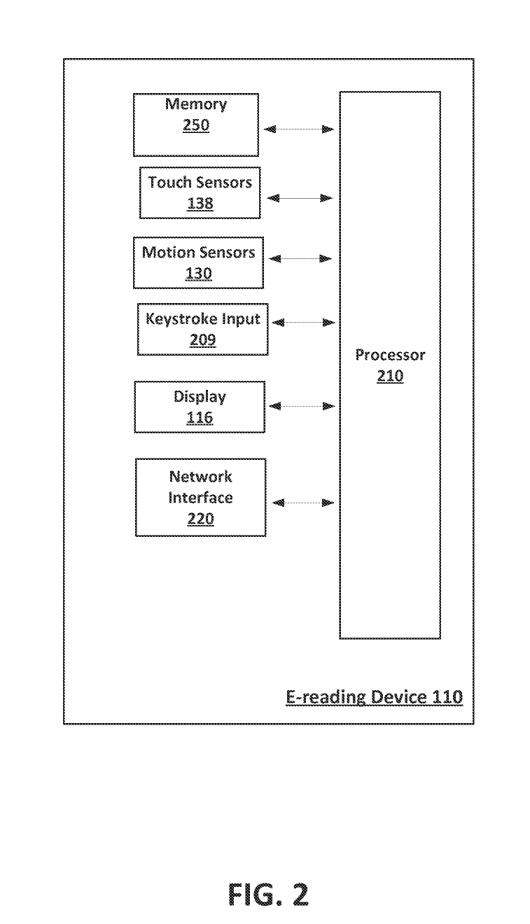

FIG. 2 illustrates further detail of e-reading device 110 as described above with respect to FIG. 1, in an embodiment. E-reading device 110 further includes processor 210, a memory 250 storing instructions and logic pertaining at least to display sensor logic 135, and page transition logic 115.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, c-reading device 110 can receive application resources 221, such as e-books or media files, that the user elects to purchase or otherwise download via the network service 120. The application resources 221 that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can optionally receive input from various sources, including touch sensor components 138, display 116, keystroke input 209 such as from a virtual or rendered keyboard, and other input mechanisms (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

In one embodiment, network interface 220 of e-reading device 110 includes wireless connectivity subsystems, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of the wireless connectivity subsystem of network interface 220 depends on the communication network in which e-reading device 110 is intended to operate, such as in accordance with Wi-Fi, Bluetooth, Near Field Communication (NFC) communication protocols, and the like.

Display 116 of e-reading device 110 includes touch functionality whereby user input commands may be accomplished via gesture actions performed at display 116. In the context of reading digitally rendered pages comprising content of an e-book, for example, come common input commands accomplished via gesture actions received at display 116 may include, for example, page turns, making annotations, adjusting illumination levels or contrast of the device display screen, and re-sizing the font size of text in the content.

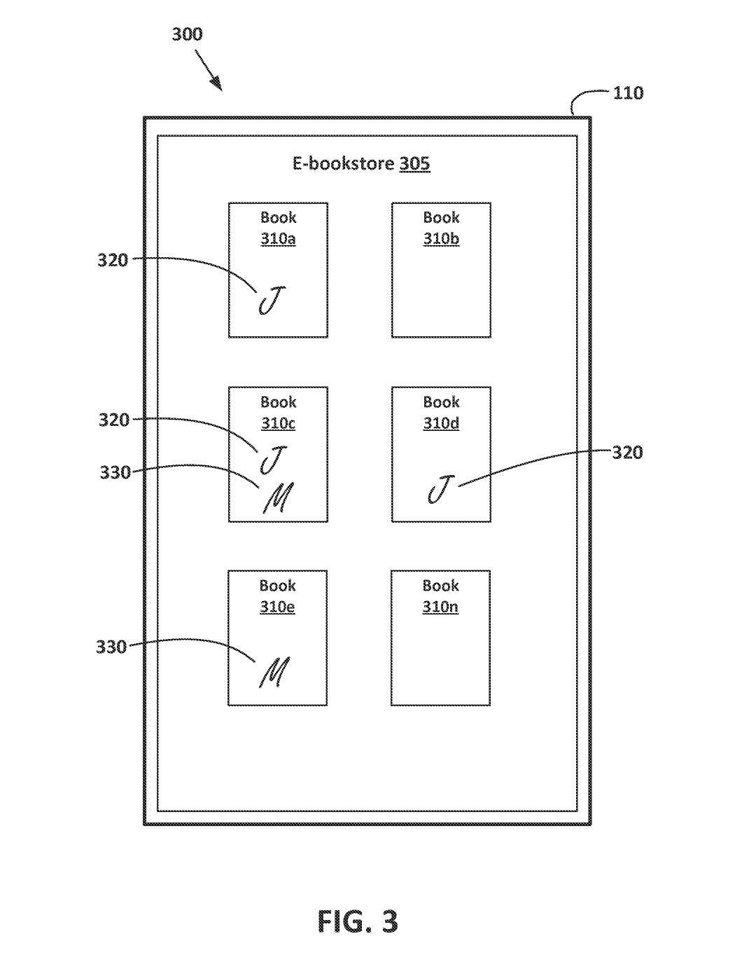

FIG. 3 illustrates a diagram of an exemplary e-library shopping page 300 on an e-reading device 110, according to an embodiment. In one embodiment, e-library shopping page 300 shows a page from e-bookstore 305. In general, e-bookstore 305 is a page in an e-bookstore that shows selections that are available for purchase. In one embodiment, e-bookstore 305 includes a number of e-book selections such as, book 310a-310n. Although FIG. 300 shows book 310a-310n, it should be appreciated that book 310a-310n may be any e-readable types, such as but not limited to, an e-novel, an e-magazine, an e-comic, a PDF, a scholarly article, and the like.

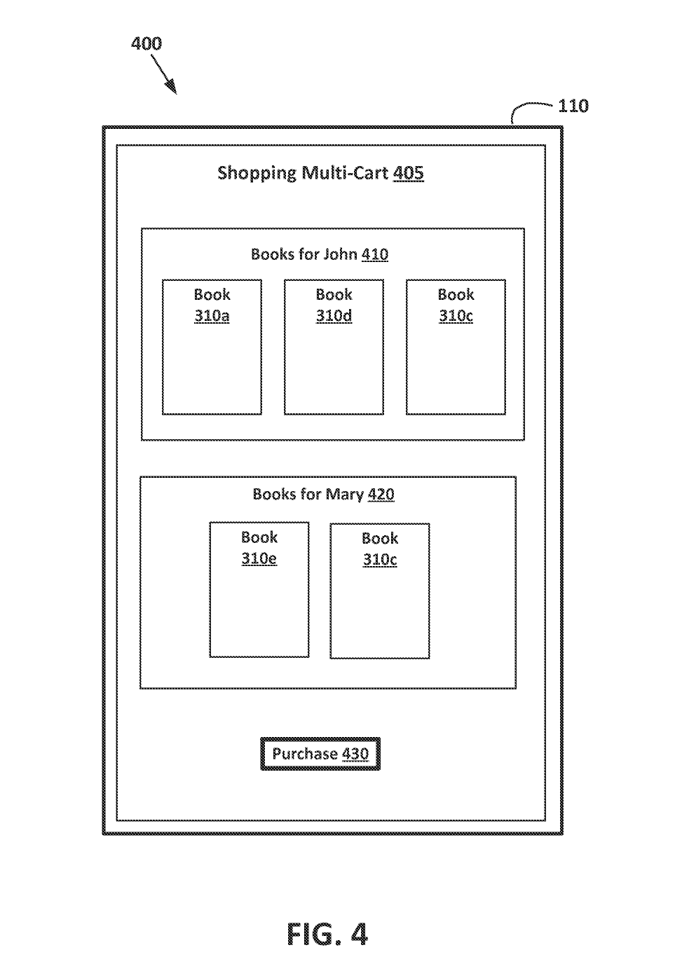

In addition, FIG. 3 includes gesture J 320 and gesture M 330. In one embodiment, gesture J 320 is a predefined gesture in the shape of a J that is used to identify the user “John”. In addition, gesture M 330 is a predefined gesture in the shape of an M that is used to identify the user's friend Mary's account. Thus, when a predefined gesture is performed on a book cover that book is marked for purchase and added to the appropriate user's account in the shopping multi-cart 405 of FIG. 4. For example, in FIG. 3, book 310a and 310d have been identified by the distinct gesture J 320. Similarly, book 310e has been identified by the distinct gesture M 330. In addition, book 310c has been identified by both the distinct gesture J 320 and the distinct gesture M 330.

Although the distinct gestures have been described as being gestures related to the first letter of the intended's name, the distinct gesture may be defined by the user and may be a letter, number, symbol, or the like. For example, in one embodiment, the user may use a stickman gesture to represent himself and use a gesture of a heart symbol to represent Mary. In another example, the user may define his gesture as a number 1 and may identify any number of other related accounts with gestures such as, but not limited to, letters, numbers, symbols, stick figures, or the like.

FIG. 4 illustrates a screen-shot type diagram of an e-library store checkout page 400, according to an embodiment. In one embodiment, store checkout page 400 includes a shopping multi-cart 405. In general, shopping multi-cart 405 may have any number of different user accounts therein. In one example, shopping multi-cart 405 has a first subsection labeled books for John 410 and a second subsection labeled books for Mary 420. In one embodiment, books for John 410 includes the three books, e.g., book 310a, book 310c and book 310d that were selected in FIG. 3. In addition, Books for Mary 420 includes book 310e and book 310c. Although the user accounts are labeled, such as, books for Mary 420, the actual title of the subsections of the shopping multi-cart 405 may be user selectable, pre-defined, or the like.

In addition, in one embodiment store checkout page 400 includes a purchase 430 icon which can be used to perform the purchase of the books. For example, the user would be able to see the list of books for each user and the cost of the purchase before finalizing the purchase by selecting purchase 430. However, in another embodiment, there may not be a purchase 430 option and instead, the enacted gesture of FIG. 3 will perform both of the identification of the recipient and the consummation of the purchases. In one embodiment, the option of having or not having the purchase 430 icon is a user selectable option.

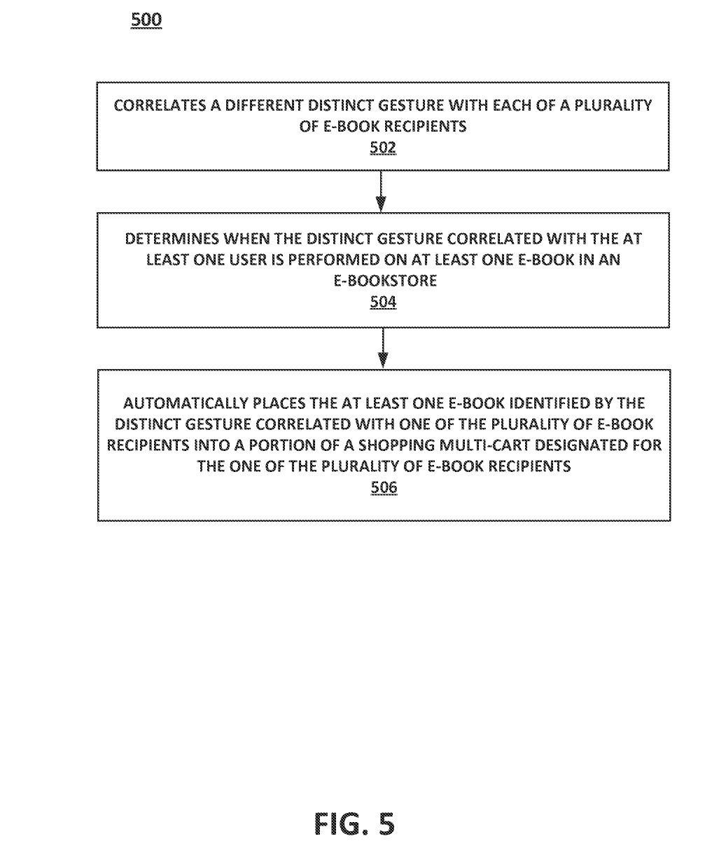

FIG. 5 illustrates a method 500 of implementing multi-cart concurrent digital e-Book transactions, according to an embodiment. For example, in one embodiment, a user's e-bookstore home page shows e-book selections that are available for purchase and allows the purchaser to identify different users as recipients for purchased e-book(s). In one embodiment, a multi-cart concurrent shopping method utilizes multi-recipient carts that are previously identified by certain predefined gestures. Then, while browsing the store, the user selects books for different recipients by drawing one or more of the predefined gestures on the book cover.

Referring now to 502 of FIG. 5 and to FIG. 3, one embodiment correlates a different distinct gesture with each of a plurality of e-book recipients. In one embodiment, a user defined input is received for each different distinct gesture for each of the plurality of e-book recipients.

For example, prior to using the cart, the user assigns gestures to specific e-library accounts. Moreover, in one embodiment, a distinct gesture may be correlated with each of a plurality of different users. For example, if John may assign a gesture in the shape of a “J”. e.g., gesture J 320, as making a book purchase for his own account. Similarly, he assigns a gesture in the shape of an “M”, e.g., gesture M 330, as making a book purchase for his friend Mary's account. In one embodiment, the distinct gesture a gesture such as, but not limited to, a letter, a number, a symbol, and a stick figure and the like. In one embodiment a gesture correlator such as motion sensor logic 137 is used to correlate the distinct gesture with the designated user.

With reference now to 504 of FIG. 5 and to FIGS. 3 and 4, one embodiment determines when the distinct gesture correlated with one of the plurality of e-book recipients is performed on at least one e-book in an e-bookstore. In one embodiment, the distinct gesture is performed on a cover representing the e-book. In another embodiment, the distinct gesture may be performed on a teaser page of the e-book. For example, the user may not be sure about purchasing the e-book based on the cover. However, when the user selects the e-book and reads the dust jacket, the introduction, a few of the teaser pages, or the like; the user may then realize that she wants to purchase the book for herself or for another recipient. At that time, the user can perform the distinct gesture on the page being sampled and the e-book will be selected and automatically placed into the cart of the e-book recipient designated by the distinct gesture.

For example, touch sensors 138 or display sensor logic 135 may be used to recognize when the distinct gesture correlated with the at least one user's account is performed on at least one e-book in an e-bookstore. In one embodiment, the e-book is an e-novel, an e-magazine, an e-comic book, a PDF, a scholarly article, or the like. Another embodiment determines that a plurality of distinct gestures correlated with the plurality of different users have been performed on a plurality of different e-books in the e-bookstore 305.

For example, as shown in FIG. 3, the distinct gesture J 320 is associated with the user John. Similarly, the distinct gesture M is associated with the user Mary. As John shops in the e-bookstore 305 he performs a gesture J 320 on book 310a and 310d. Similarly, he performed the distinct gesture M 330 on book 310e. In addition, book 310c has been marked by both the distinct gesture J 320 and the distinct gesture M 330.

With reference now to 506 of FIG. 5 and to FIGS. 3 and 4, one embodiment automatically places the at least one e-book identified by the distinct gesture correlated with one of the plurality of e-book recipients into a portion of a shopping multi-cart designated for the one of the plurality of e-book recipients. In other words, an e-book selection module such as processor 210 can receive the e-book selected input from the distinct gesture recognition module and place the at least one e-book in the at least one user's subsection of a shopping multi-cart.

In another embodiment, when a plurality of e-books have been designated by distinct gestures, each of the plurality of different e-books may be placed into an associated e-book recipient subsection of a shopping multi-cart for each e-book recipient as designated by the distinct gesture for each e-book recipient. For example, as shown in FIG. 4, shopping multi-cart 405 has a first subsection labeled books for John 410 and a second subsection labeled books for Mary 420. In one embodiment, books for John 410 includes the three books, e.g., book 310a, book 310c and book 310d that were marked with the distinct gesture J 320. In addition, Books for Mary 420 includes book 310e and book 310c that were marked with the distinct gesture M 330.

In one embodiment, once the selection of e-books has been completed, the user can view the selections in the shopping multi-cart 405 as shown in FIG. 4. Thus, when the user views his cart, he will see a list of books for each user (John and Mary) which he can then review for correctness. In one embodiment, when the user is ready to check out, she can activate the purchase 430 option on the shopping multi-cart page 400 to purchase the at least one e-book.

In another embodiment, the enacted gesture both identifies the gift recipient and also consummates the purchases. In other words, when a distinct gesture is determined, one embodiment automatically purchases the at least one e-book identified by the distinct gesture and provides the at least one e-book in an account of the at least one user.

### Example Computer System Environment

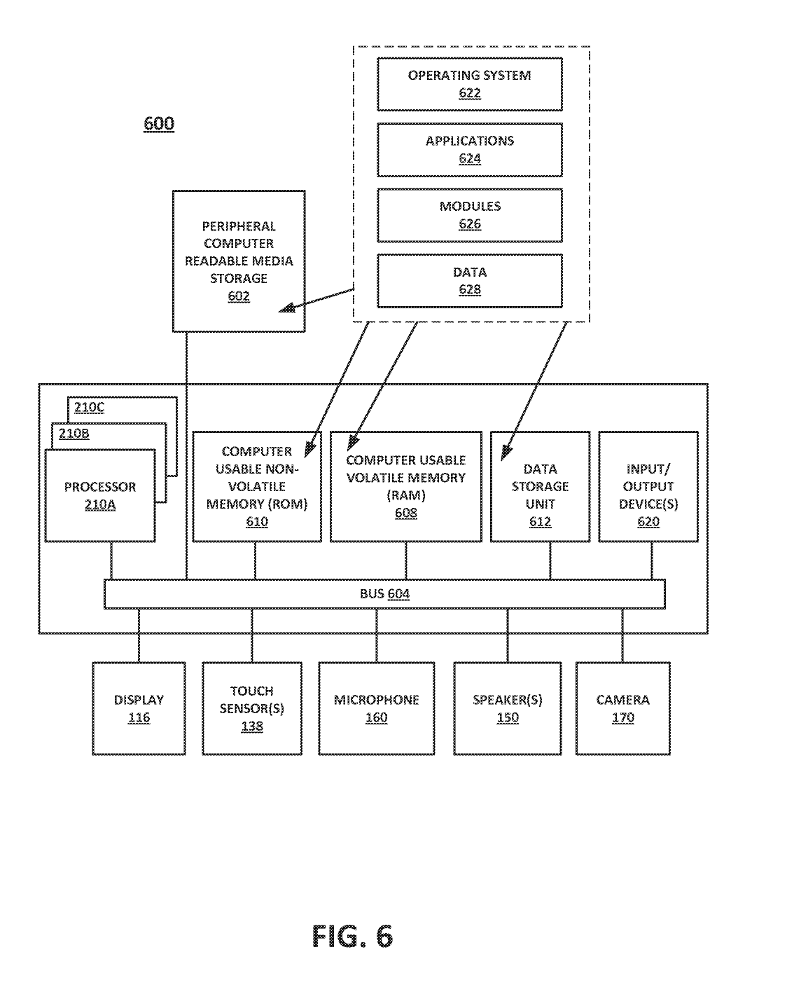

With reference now to FIG. 6, all or portions of some embodiments described herein are composed of computer-readable and computer-executable instructions that reside, for example, in computer-usable/computer-readable storage media of a computer system. That is, FIG. 6 illustrates one example of a type of computer system 600 that can be used in accordance with or to implement various embodiments of an e-reading device, such as e-reading device 110, which are discussed herein. It is appreciated that computer system 600 of FIG. 6 is only an example and that embodiments as described herein can operate on or within a number of different computer systems.

System 600 of FIG. 6 includes an address/data bus 604 for communicating information, and a processor 210A coupled to bus 604 for processing information and instructions. As depicted in FIG. 6, computer system 600 is also well suited to a multi-processor environment in which a plurality of processors 210A, 210B, and 210C are present. Processors 210A, 210B, and 210C may be any of various types of microprocessors. For example, in some multi-processor embodiments, one of the multiple processors may be a touch sensing processor and/or one of the processors may be a display processor. Conversely, computer system 600 is also well suited to having a single processor such as, for example, processor 210A.

System 600 also includes data storage features such as a computer usable volatile memory 608, e.g., random access memory (RAM), coupled to bus 604 for storing information and instructions for processors 210A, 210B, and 210C. System 600 also includes computer usable non-volatile memory 610, e.g., read only memory (ROM), coupled to bus 604 for storing static information and instructions for processors 210A, 210B, and 210C. Also present in computer system 600 is a data storage unit 612 (e.g., a magnetic or optical disk and disk drive) coupled to bus 604 for storing information and instructions.

Computer system 600 of FIG. 6 is well adapted to having peripheral computer-readable storage media 602 such as, for example, a floppy disk, a compact disc, digital versatile disc, universal serial bus “flash” drive, removable memory card, and the like coupled thereto. In some embodiments, computer-readable storage media 602 may be coupled with computer system 600 (e.g., to bus 604) by insertion into removable a storage media slot.

System 600 also includes or couples with display 116 for visibly displaying information such as alphanumeric text and graphic images. In some embodiments, computer system 600 also includes or couples with one or more optional touch sensors 138 for communicating information, cursor control, gesture input, command selection, and/or other user input to processor 210A or one or more of the processors in a multi-processor embodiment. In some embodiments, computer system 600 also includes or couples with one or more optional speakers 150 for emitting audio output. In some embodiments, computer system 600 also includes or couples with an optional microphone 160 for receiving/capturing audio inputs. In some embodiments, computer system 600 also includes or couples with an optional digital camera 170 for receiving/capturing digital images as an input.

Optional touch sensor(s) 138 allows a user of computer system 600 (e.g., a user of an eReader of which computer system 600 is a part) to dynamically signal the movement of a visible symbol (cursor) on display 116 and indicate user selections of selectable items displayed. In some embodiment other implementations of a cursor control device and/or user input device may also be included to provide input to computer system 600, a variety of these are well known and include: trackballs, keypads, directional keys, and the like.

System 600 is also well suited to having a cursor directed or user input received by other means such as, for example, voice commands received via microphone 160. System 600 also includes an input/output (I/O) device 620 for coupling computer system 600 with external entities. For example, in one embodiment, I/O device 620 is a modem for enabling wired communications or modem and radio for enabling wireless communications between computer system 600 and an external device and/or external network such as, but not limited to, the Internet. I/O device 620 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 6, various other components are depicted for computer system 600. Specifically, when present, an operating system 622, applications 624, modules 626, and/or data 628 are shown as typically residing in one or some combination of computer usable volatile memory 608 (e.g., RAM), computer usable non-volatile memory 610 (e.g., ROM), and data storage unit 612. For example, modules 626 may include an application module for providing an image based decision platform for a user.

In some embodiments, all or portions of various embodiments described herein are stored, for example, as an application 624 and/or module 626 in memory locations within RAM 608, ROM 610, computer-readable storage media within data storage unit 612, peripheral computer-readable storage media 602, and/or other tangible computer readable storage media.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A system for multi-cart concurrent digital e-book transactions comprising:
a gesture correlator to correlate a distinct gesture with an e-book recipient wherein there may be a plurality of e-book recipients each with a correlated and different distinct gesture;
a gesture recognition module to recognize an e-book as being designated for the e-book recipient when the distinct gesture correlated with the e-book recipient is performed on the e-book in an e-bookstore; and
an e-book multi-cart module to place the e-book designated for the e-book recipient in a subsection of a shopping multi-cart, said subsection designated as an account for the e-book recipient correlated with the distinct gesture.

2. The system of claim 1 wherein the distinct gesture is selected from the group consisting of: a letter, a number, a symbol, and a stick figure.

3. The system of claim 1 further comprising:
a purchase icon on a shopping multi-cart page to provide a purchase capability for a user to purchase the at least one e-book for the e-book recipient.

4. The system of claim 1 further comprising:
the e-book multi-cart module additionally purchases the e-book and provides the e-book to an e-book library for the e-book recipient correlated with the distinct gesture.

5. The system of claim 1 wherein the e-book is selected from the group consisting of: an e-novel, an e-magazine, an e-comic book, a PDF, and a scholarly article.

6. The system of claim 1 wherein the distinct gestures is a user designed gesture.

7. The system of claim 6 further comprising:
the gesture recognition module to recognize a plurality of e-books as being designated for a plurality of different e-book recipients when a plurality of different distinct gestures are performed on one or more of the plurality of e-books in the e-bookstore; and
the e-book multi-cart module to place each of the plurality of e-books in an appropriate designated e-book recipient subsection of a shopping multi-cart for each e-book recipient as designated by each of the plurality of different distinct gestures.

8. A computing device comprising:
a memory that stores a set of instructions;
a display screen having touch functionality;
a processor that access the instructions in memory, the processor further configured to implement a method for multi-cart concurrent digital e-Book transactions comprising:
correlating a different distinct gesture with each of a plurality of e-book recipients;
determining when the distinct gesture correlated with one of the plurality of e-book recipients is performed on at least one e-book in an e-bookstore; and
automatically placing the at least one e-book identified by the distinct gesture correlated with one of the plurality of e-book recipients into a portion of a shopping multi-cart designated for the one of the plurality of e-book recipients.

9. The computing device of claim 8 wherein the distinct gesture is selected from the group consisting of: a letter, a number, a symbol, and a stick figure.

10. The computing device of claim 8 further comprising:
providing a purchase icon on a shopping multi-cart page to provide a purchase capability for a user to purchase the at least one e-book in the shopping multi-cart.

11. The computing device of claim 8 further comprising:
automatically purchasing the at least one e-book identified by the distinct gesture and providing the at least one e-book into an e-reader account of the at least one of the plurality of e-book recipients.

12. The computing device of claim 8 wherein the e-book is selected from the group consisting of: an e-novel, an e-magazine, an e-comic book, a PDF, and a scholarly article.

13. The computing device of claim 8 further comprising:
receiving a user defined input for the different distinct gesture for each of the plurality of e-book recipients.

14. The computing device of claim 13 further comprising:
determining that a plurality of distinct gestures correlated with the plurality of e-book recipients has been performed on a plurality of different e-books in the e-bookstore; and
placing each of the plurality of different e-books into an associated e-book recipient subsection of a shopping multi-cart for each e-book recipient as designated by the distinct gesture for each e-book recipient.

15. A non-transitory computer implemented method for performing multi-cart concurrent digital e-Book transactions, said method comprising:
receiving a user defined input comprising a different distinct gesture for each of a plurality of e-book recipients;
correlating each different distinct gesture with each of the plurality of e-book recipients;
determining when the distinct gesture correlated with one of the plurality of e-book recipients is performed on at least one e-book in an e-bookstore; and
automatically placing the at least one e-book identified by the distinct gesture correlated with one of the plurality of e-book recipients into a portion of a shopping multi-cart designated for the one of the plurality of e-book recipients.

16. The non-transitory computer implemented method of claim 15 wherein the distinct gesture is selected from the group consisting of: a letter, a number, a symbol, and a stick figure.

17. The non-transitory computer implemented method of claim 15 wherein the distinct gesture is performed on a portion of the e-book from the group consisting of: a cover, a dust jacket, an introduction page, and a teaser page.

18. The non-transitory computer implemented method of claim 15 further comprising:
automatically purchasing the at least one e-book identified by the distinct gesture and providing the at least one e-book into an e-reader account of the at least one of the plurality of e-book recipients.

19. The non-transitory computer implemented method of claim 15 wherein the e-book is selected from the group consisting of: an e-novel, an e-magazine, an e-comic book, a PDF, and a scholarly article.

20. The non-transitory computer implemented method of claim 15 further comprising:
determining that a plurality of distinct gestures correlated with each of the plurality of different e-book recipients have been performed on a plurality of different e-books in the e-bookstore; and
placing each of the plurality of different e-books into an associated user portion of the shopping multi-cart for each of the plurality of different e-book recipients as designated by each distinct gesture.
